(19) United States
(12) Patent Application Publication
(10) Pub. No.: US 2004/0026014 A1
(43) Pub. Date: Feb. 12, 2004

(54) Method for fabricating a laminar element and machine for fabricating same and laminar element obtained by said method

(76) Inventor: Jaume Teixidor Casanovas, Barcelona (ES)

Correspondence Address: STEINBERG & RASKIN, P.C., 1140 AVENUE OF THE AMERICAS, 15th FLOOR, NEW YORK, NY, 10036-5803, US

(21) Appl. No.: 10/450,737

(22) PCT Filed: Dec. 24, 2001
(86) PCT No.: PCT/IB01/02720

(30) Foreign Application Priority Data
Dec. 26, 2000 (ES) P-200003105

(51) Int. Cl. B32B 31/00

(52) U.S. Cl. 156/199; 156/205; 156/224; 156/459

(57) ABSTRACT

The method includes the stages of gluing of a plurality of layers of sheet material (2, 3, 4); and stamping of all the layers (2, 3, 4) together; with sticking together of the previously glued zones being carried out at the same time as the stamping of all the layers (2, 3, 4). The machine includes gluing stations (12) (2, 3, 4); and a stamping station (13) which includes a pair of pressing elements, which stamp and stick together said previously glued layers. The laminar element is formed from a plurality of layers of sheet material (2, 3, 4) and can include one or several cavities (5) of polygonal profile, or else said layers are of sinusoidal profile. A higher manufacturing output of the laminar layer is achieved and it permits the forming of a laminar element with cavities or undulations of any desired shape, without limitation on the thickness of the layers.

This invention relates to a method for fabricating a laminar element, a machine for fabricating it and the laminar element obtained by said method.

Moreover, this invention also relates to several specific applications of the laminar element, since it can be used as a reinforcing, packaging or protecting element.

### BACKGROUND OF THE INVENTION

Known in the art are various laminar elements which include cavities for different applications, such as for holding foods.

Usually for the transportation of foods in cardboard boxes, mainly fruit, a number of trays are used, which trays are provided with a plurality of cavities in which are placed the fruits to be transported. This type of trays are usually known as alveolar trays.

Most of the currently known alveolar trays are made of plastic, and they have the disadvantage that they are not very ecological, since recycling them is not very profitable. These plastic alveolar trays are manufactured by thermoforming.

Also currently known is another type of alveolar trays that do not have ecological disadvantages, which are manufactured from paper pulp. The method for fabricating this type of trays includes a pressing stage with a mould to eliminate the water from the paper pulp, after which the paper pulp is placed in an oven until the tray has been formed into the desired shape.

This type of alveolar trays has the disadvantage of being excessively expensive and the process for fabricating them very slow, which results in low manufacturing productivity.

An alveolar tray, together with the machine and the fabrication method was disclosed in patent WO 99/33645, by the same holder as in this application, in order to resolve these disadvantages.

The alveolar tray disclosed in this patent includes a plurality of cavities which are formed from a number of star-shaped cuts made in the layers of cardboard which make up the tray and from a circular split also made in said layers.

In the method disclosed in that patent the sheets which form the laminar element are attached to each other before the stamping phase, which limits the thickness of the layers which compose it.

Moreover, this method is carried out by means of alternating cycles, that is, each operation is carried out with the material at a standstill. That non-continuous fabricating method means that there is little precision in placement of the layers of sheet material.

That alveolar tray managed to resolve the disadvantages mentioned above, but it was found that the laminar element formed by said tray was not suitable for other applications requiring greater strength.

Also known is the use of corrugated board for different applications. The corrugated board known at present comprises a single layer of corrugated profile, a smooth upper layer and a lower layer which is also smooth.

The currently known method for fabricating corrugated board includes a stage of hot-stamping of the board. It is essential that the board be at a high temperature so that it softens sufficiently for it to acquire its characteristic shape.

The stamping is carried out on cogwheels of large size, and when the board is placed on these cogwheels it acquires a totally smooth layer so that it maintains its corrugated shape, for if not the previously corrugated layer of board would return to its flat shape when it was withdrawn from the cogwheel.

The corrugated board currently used therefore has the disadvantage that the corrugated layer has to be of low thickness in order to stamp it, which stamping must, furthermore, be carried out hot, which increases its fabricating cost.

### DESCRIPTION OF THE INVENTION

The method, the machine and the laminar element of the invention manage to resolve the disadvantages mentioned, while also presenting other advantages which will be described below.

The method of this invention for fabricating a laminar element includes the stages of gluing of a plurality of layers of sheet material; and stamping of all the layers together; and it is characterised in that the sticking together of the previously glued zones is carried out at the same time as the stamping of all the layers.

Advantageously, the gluing and stamping of the layers is carried out in a continuous and synchronised manner.

The method of this invention can also include a pre-die-cutting stage of said plurality of layers of sheet material, with a number of cuts being made in said layers.

Advantageously the pre-die-cutting of said plurality of layers of sheet material is also carried out continuously and synchronised with the other stages. If desired, and depending on the end product to be produced, in the pre-die-cutting stage a number of fold-lines can also be made on said layers.

The method of this invention also includes a final stage of cutting of all the layers together.

The method can also include a stage of drawing of all the layers together, if wished. In this case, said drawing stage is carried out before the gluing, and the layers are separated in order to glue them.

According to a second aspect, the machine of this invention includes:

a plurality of gluing stations for the layers of sheet material; and

a stamping station, in which all the layers together are stamped; and

it is characterised in that:

said stamping station includes a pair of pressing elements, which stamp and glue together said previously glued layers.

Advantageously, said gluing stations are adhesive-spraying stations.

The machine of this invention can also include a plurality of pre-die-cutting stations, on which a number of cuts and/or fold-lines are made on the layers of sheet material.

Preferably, said pre-die-cutting stations include a pair of rollers which are synchronised with each other.

Advantageously, the machine of this invention also includes a cutting station situated downstream of the stamping station.

According to two alternative embodiments, said pressing elements are rollers provided with at least one projecting part and one complementary inlet or they are cogged belts.

Advantageously, one of said pressing elements is of a deformable material with the pressure, e.g. foam. This way, said pressing elements adapt automatically to any thickness.

If so wished, the machine of this invention can also include a station for drawing of all the layers of sheet material together.

In this case, the drawing station is situated upstream of the gluing stations, and said gluing stations include a separating station associated with them, which permits separation of the layers from each other for gluing them.

The machine and the method of this invention achieves higher fabricating output of the laminar element, as it is carried out continuously and maintaining a constant tension in all the layers which form the laminar element. A perfect synchronisation of all stations of the machine and of all stages of the fabricating method is also achieved, permitting correct positioning of the flaps which form the cavities of the laminar element.

Moreover, a laminar element can be formed with cavities or corrugations of any desired shape, without limitation on the thickness of the layers.

It also permits the process to be carried out cold, thereby achieving a significant saving in fabrication costs.

Furthermore, the laminar element retains memory of its shape, so that placement of the smooth layer as in the case of the present corrugated board is not necessary during its fabricating process.

According to a first embodiment, the laminar element of this invention is formed from a plurality of layers of sheet material and includes at least one cavity, each cavity being formed from a number of cuts and folds formed in several layers making up the laminar element, defining a number of flaps, and is characterised in that said flaps form cavities of polygonal profile.

Thanks to this characteristic, a laminar element of great strength is achieved due to the polygonal layout of the cavities, so that it can be used for applications other than that of alveolar tray, as will be described below.

Advantageously, the flaps of one of the layers are displaced with respect to the flaps of the adjacent layer or layers, and the flaps of two adjacent layers are glued to each other in the zones of mutual contact.

According to a preferred embodiment of the laminar element of this invention, said cavity has a hexagonal profile.

According to an alternative embodiment, said cavity presents a quadrangular profile.

The flaps which define a cavity of hexagonal profile are three in number, with each of said flaps being triangular and each flap including three fold lines which define a rectangular central zone, a triangular upper zone and two side zones which are also triangular.

Where necessary, each of said cavities includes at least one cap of laminar material which covers the hollow left by the cuts in the cavity, the profile of said cap or caps coinciding substantially with the profile of the cavity.

Said cap is situated, preferably, interposed between two of the layers which make up the laminar element.

The laminar materials which form the laminar element of this invention can be cardboard and/or paper.

According to a first use, the laminar element of this invention can be used as a reinforcing element, which is formed from a pair of laminar elements of this invention provided with a plurality of cavities, and it is characterised in that said laminar elements are attached to each other in such a way that the projecting part of the cavities is directed towards the interior of the reinforcing element.

According to a preferred embodiment of the reinforcing element, the cavities of both laminar elements are arranged in quincunx manner, so that the cavities of the first laminar element fit into at least some of the hollows left by the cavities of the second laminar element.

In the reinforcing element of this invention, the cavities of both laminar elements can have a hexagonal profile, with the cavities of both laminar elements being arranged in such a way that a hollow left by said cavities is surrounded by three cavities of the first laminar element and by three cavities of the second laminar element.

This application of the laminar element of this invention achieves a very strong reinforcing element, which can be used, for example, to reinforce doors. In this case, a reinforcing element is achieved which is very much cheaper than those currently used for doors, which are usually made of wood.

According to a second utilisation, the laminar element of this invention can be used as a packaging element, and would include at least one cavity and a cap interposed between two layers of sheet material, covering the hollow left by the cuts in the cavity or cavities.

Said packaging can include a layer of sheet material by way of cover.

This packaging can be used to replace the currently known packaging made of plastic, a material much less ecological than cardboard.

According to a third use, the laminar element of this invention can be used as a protecting element, which is formed from a single laminar element, which includes a plurality of cavities, characterised in that it includes a plurality of fold-lines between the cavities.

This protecting element can be used to package fragile articles, and can replace the current protecting elements made of plastic.

According to a second embodiment, the laminar element of this invention is of sinusoidal profile and is characterised in that it includes at least two layers of sheet material of sinusoidal profile attached to each other.

If so wished, each layer of the laminar material includes a plurality of cuts, the cuts of one layer being displaced in relation to the cuts of the adjacent layer or layers, with said cuts running the length of the undulations of said layer.

According to a preferred use, the reinforcing element is formed by at least two laminar elements of sinusoidal profile attached to each other, and is characterised in that the undulations of one of the laminar elements are substantially perpendicular or parallel to the undulations of the adjacent laminar element or elements.

Is so wished, the undulations of one of the laminar elements are partially incrusted in the undulations of the adjacent laminar element or elements.

### BRIEF DESCRIPTION OF THE DRAWINGS

For a better understanding of all that has been set out, some drawings are attached which show, schematically and solely by way of non-restrictive example, a practical case of embodiment.

FIG. 1 is a schematic view of a first embodiment of the machine of this invention;

FIG. 2 is a schematic view of a second embodiment of the machine of this invention;

FIG. 3 is a schematic view of a third embodiment of the machine of this invention;

FIG. 4 is a schematic view of a fourth embodiment of the machine of this invention;

FIG. 5 is a plan view of the zone of the flaps which form a cavity of the laminar element of this invention, according to a first embodiment;

FIG. 6 is a perspective view of a cavity of the laminar element of this invention, according to the embodiment shown in FIG. 5;

FIG. 7 is a plan view of the zone of the flaps which form a cavity of the laminar element of this invention, according to a second embodiment;

FIG. 8 is a perspective view of a cavity of the laminar element of this invention, according to the embodiment shown in FIG. 7;

FIG. 9 is a perspective view of the layers of sheet material, in exploded view, that form packaging from the laminar element of this invention;

FIG. 10 is a perspective view of a protecting element formed from the laminar element of this invention;

FIG. 11 is a schematic view of the arrangement of the cavities of two laminar elements of this invention, forming a reinforcing element;

FIG. 12 is a perspective view of an application such as corrugated board of a number of laminar elements of this invention according to a third embodiment, attached to each other;

FIG. 13 is an elevation view of a sectioned corrugation of the laminar element of FIG. 12;

FIGS. 14 and 15 are plan views of two different sheets which form the laminar element of FIG. 12 prior to their stamping and gluing together;

FIG. 16 is a perspective view of a reinforcing element according to a second embodiment made up of two laminar elements attached to each other;

FIG. 17 is a perspective view of a reinforcing element similar to that of FIG. 16, with the undulations of a laminar element partially incrusted in the adjacent laminar element;

FIG. 18 is a sectioned elevation view of the reinforcing element shown in FIG. 17, showing the zone in which the undulations are partially incrusted;

FIG. 19 is an elevation view of a reinforcing element according to the invention, in which the undulations of two adjacent laminar elements are substantially parallel to each other; and

FIG. 20 is a plan view of a plurality of trays made with an alternative embodiment of the machine shown in FIG. 3, said trays being joined one to each other before passing by the stamping station.

### DESCRIPTION OF PREFERRED EMBODIMENTS

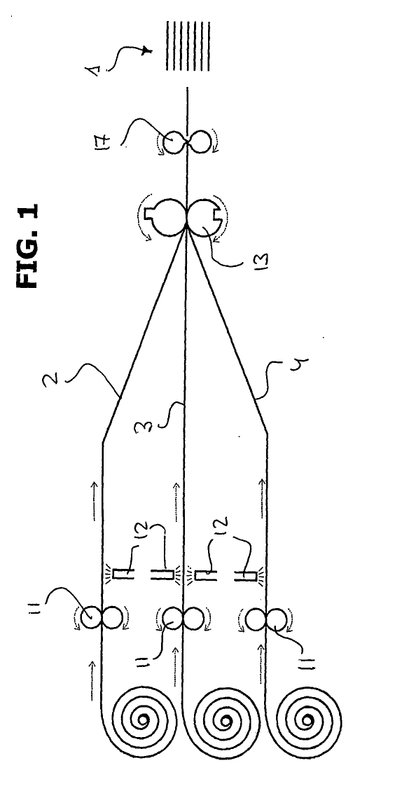

FIGS. 1 to 4 show alternative embodiments of the machine of this invention. In the first place, it should be stated that in these embodiments machines are shown for the fabricating of laminar elements, generally indicated with number reference 1, formed by three layers 2, 3 and 4. It is nevertheless evident that the laminar element 1 of this invention can be formed from two or more layers of sheet material.

According to the embodiment shown in FIG. 1, the machine of this invention includes:

three pre-die-cutting stations 11, in which a number of cuts and/or fold-lines are made in the layers of sheet material 2, 3, 4;

four gluing stations 12 of the layers of sheet material 2, 3, 4; and

one stamping station 13, in which all the layers 2, 3, 4 are stamped together; and

a cutting station 17, in which the laminar elements 1 are cut individually.

According to the embodiment shown in the figures, said pre-die-cutting stations 11 include a pair of rollers which are synchronised with each other, in such a way that the pre-die-cutting of the layers 2, 3, 4 is carried out continuously.

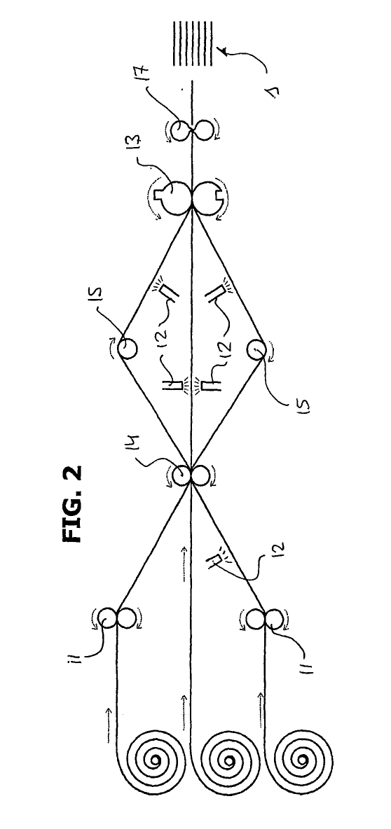

Moreover, said gluing stations 12 are stations for spraying of the glue, and said stamping stations 13 of FIGS. 1 and 2 include a pair of rollers, so that the stamping of the layers 2, 3, 4 is carried out continuously, with sticking together of the previously glued zones also being carried out.

For its part, the cutting station 17 also includes a pair of rollers each provided with a cutter, which cut the laminar element 1 individually.

The embodiment of the machine of this invention of FIG. 2 also includes a drawing station 14 of all the layers of sheet material 2, 3, 4 together.

The drawing station 14 is situated upstream of the gluing stations 12, including also a separating station 15 associated with the gluing stations 12, which permits separation of the layers 2, 3, 4 from each other in order to glue them.

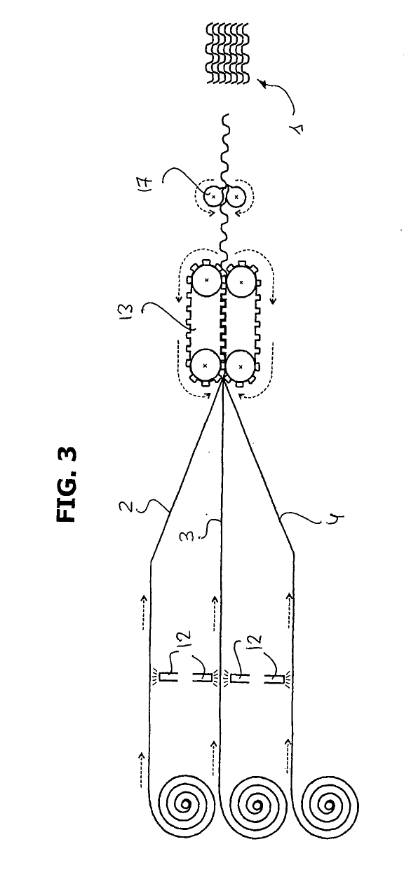

In the embodiment of the machine of this invention shown in FIG. 3 the pre-die-cutting station has been eliminated, since it is not necessary for the fabricating of, for example, laminar elements which have a sinusoidal profile. In this case, the undulations will run transversally with respect to the direction of advance of the layers 2, 3, 4.

The other difference from the machine of FIG. 3 is that the stamping station 13 is formed by a pair of cogged belts, on which said sinusoidal profile is formed.

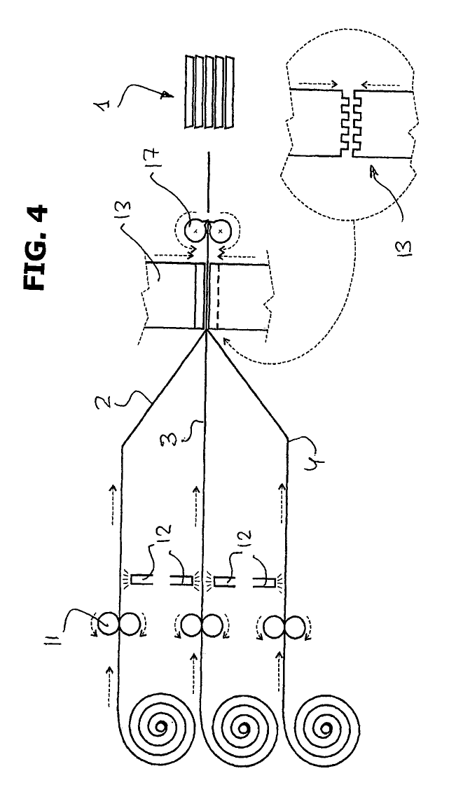

The machine of FIG. 4 is also designed for fabricating a laminar element of sinusoidal profile 1. In this case, unlike the embodiment of FIG. 3, the undulations will run longitudinally with respect to the direction of advance of the layers 2, 3, 4.

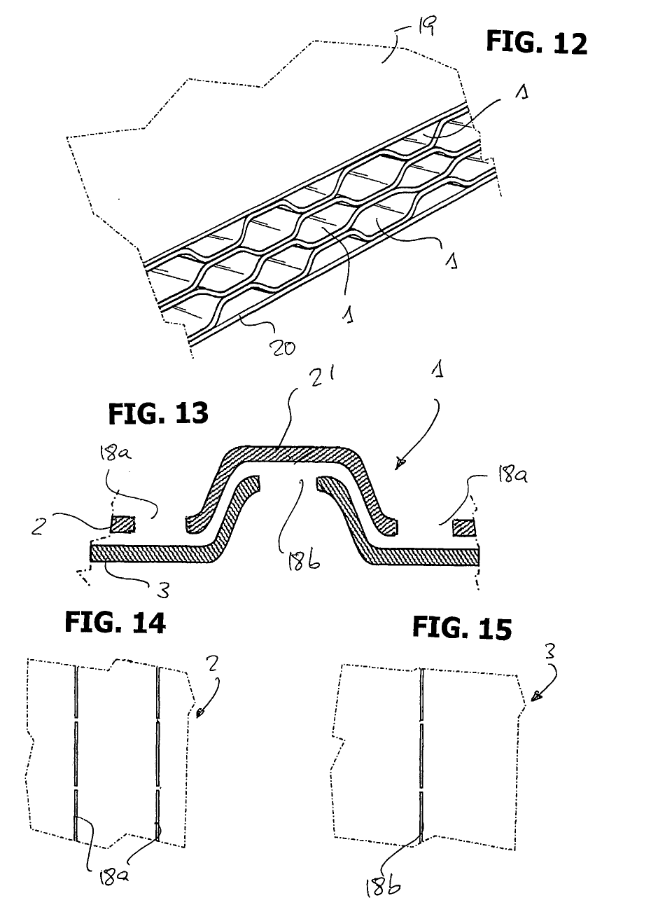

In this embodiment, the machine does include a pre-die-cutting station 11 for making the cuts, which can be seen in FIGS. 13 to 15.

The stamping station 13 is formed by a pair of complementary plates provided with a number of complementary projections and inlets, as can be seen in the detail of FIG. 4.

If wished, the feeding of the layers of sheet material can be made at different speeds, if it is desired to feed more material of one of said layers. This is specially important when a sinusoidal profile laminar material is made, since the inferior layer needs more material.

The method of this invention includes the following stages:

gluing of said layers of sheet material 2, 3, 4;

stamping of all the layers 2, 3, 4 together for the formation of cavities or undulations, together with gluing together of all the layers 2, 3, 4, to which glue had previously been applied; and

cutting of the set of all the layers 2, 3, 4 glued together and stamped.

In the method of this invention the pre-die-cutting, gluing, stamping and cutting of the layers 2, 3, 4 is carried out continuously and in a synchronised manner.

If necessary, the method of this invention also includes a prior stage of pre-die-cutting of a plurality of layers of sheet material 2, 3, 4, in which a number of cuts and/or fold-lines are made on said layers.

The method can also include a stage of drawing of all the layers of sheet material 2, 3, 4 together, which can be carried out before the gluing, with the sheets having to be separated in order to glue them.

The sticking together of the glued zones is carried out at the same time as the stamping of all the layers on said stamping station 13.

The machine and the method of this invention achieve a high production rate thanks to the pre-die-cutting, gluing and stamping being carried out continuously and in synchronisation. In order to achieve correct fabrication of the laminar element of this invention the synchronisation of all the components of the machine is very important.

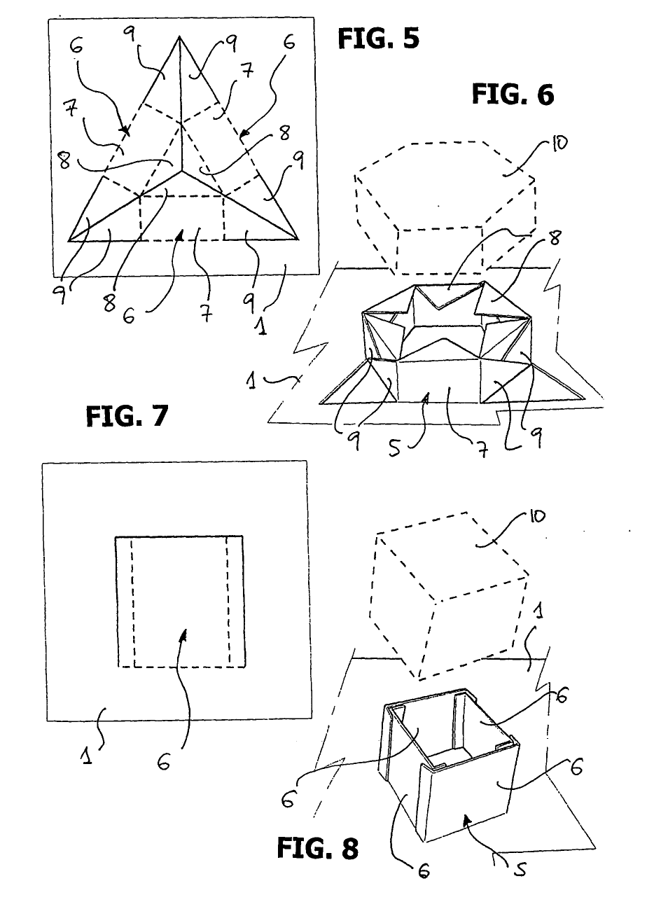

FIGS. 5 to 8 show two embodiments of the laminar element of this invention.

The laminar element of this invention, marked generally with number reference 1, includes, according to these embodiments, at least one cavity 5 of polygonal profile formed from flaps 6 defined by means of a number of cut-outs and fold-lines which are formed in the layers of sheet material 2, 3, 4 with the machine described previously and following the previous method.

It is evident that there can be any number of cavities 5 in the laminar element 1 of this invention, depending on the desired utilisation. It should also be stated that the layout of said cavities can also be any layout, whether regular or not, as long as it is polygonal.

It is precisely this characteristic of the cavities being polygonal which differentiates the polygonal element of this invention from the alveolar tray disclosed in patent WO 99/33645. It has been shown that the circular profile of the cavities of said tray is not suitable for certain applications which require high strength.

FIGS. 5 and 6 show an embodiment in which the cavities 5 have a hexagonal profile, in this case regular. It should be pointed out that for reasons of clarity only a single cavity 5 has been shown, though it should be understood that the laminar element can have any suitable number of cavities 5.

In this case, the flaps 6 that form the cavity 5 are three in number and are triangular in shape, as can be seen from FIG. 5. Each one of these flaps has a number of fold-lines which define a rectangular central zone, a triangular upper zone 8 and two side zones 9 which are also triangular.

The folding of said flaps 6 brings the side zones 9 of a flap 6 into contact with one of the side zones 9 of the adjacent flap 6, as can be seen from FIG. 6.

In the case of the embodiment shown, the laminar element 1 includes two layers of sheet material, so that the flaps of one layer are displaced with respect to the flaps of the layer against it, leaving the cavity 5 as shown in FIG. 6. The zones of the flaps 6 which are in contact with each other are glued, thus increasing the strength of the cavity 5.

If it is wished to increase the strength of said cavity 5, a cap 10 can be placed inside it, on the exterior or between the two layers of sheet material.

The embodiment of FIGS. 7 and 8 is similar to the previous embodiment. The difference between the two embodiments is that the cavity is quadrangular in this case and the laminar element 1 is formed from four layers of sheet material.

The folding of the flaps 6 and the placement of the four flaps 6 displaced in relation to each other permits a cavity 5 to be achieved as shown in FIG. 8. In this case also, the zones of the flaps 6 in contact with each other are glued, and a cap 10 may also be fitted.

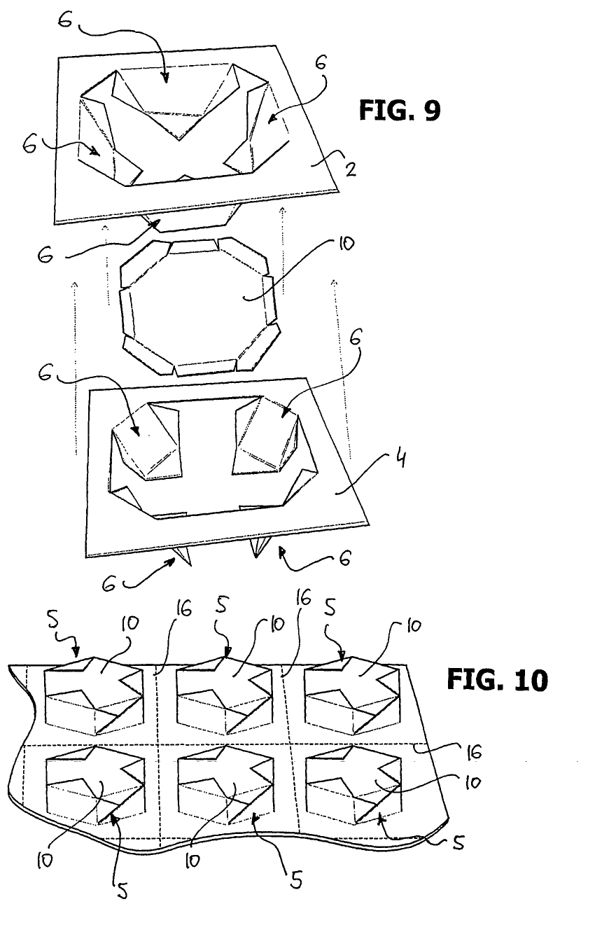

FIGS. 9, 10 and 11 show three specific utilisations of the laminar element of the previous embodiments.

FIG. 9 shows a packaging element formed from a laminar element of this invention, in this case provided with a single cavity. For reasons of clarity, the layers of sheet material 2, 4 and the cap 10 have been shown in exploded form.

Although the cavity 5 can be of any suitable polygonal section, in the case of the embodiment shown it is octagonal. Said cavity 5 is formed by four flaps 6 of the first layer of sheet material 2 and by four flaps 6 of the second layer of sheet material 4, so that its position is displaced. The packaging element also includes a cap 10 interposed between the two layers 2, 4, and the zones of the layers 2, 4 and of the cap 10 in contact with each other are glued.

The packaging shown in FIG. 9 can also include a sheet by way of cover (not shown) in order to close the packaging. Clearly, and depending on the product the packaging is used for, it can include a layer of some material of different characteristics.

It should be noted that the packaging can include more than one cavity 5, where it is desired that the packaging hold more than one product. For example, the packaging could include four cavities 5 for holding four fruits.

FIG. 10 shows a second utilisation of the laminar element 1 of this invention, in this case as a protecting element destined, for example, for packaging fragile articles and preventing them being broken by blows.

In this case, the section of the cavities is hexagonal, though it could also be of any suitable polygonal section. As in the case of the packaging described previously, the cavities 5 are formed from flaps 6 with the interposition of a cap 10, and the zones in contact with each other are glued.

The protecting element shown in FIG. 10 includes a plurality of cavities 5, which are separated by fold-lines 16.

The laminar element of this invention could also be used as a reinforcing element, for example for doors. Said laminar element is formed by two laminar elements 1 which include a plurality of cavities 5, with said laminar elements 1 arranged facing each other, that is, with the projecting part of the cavity 5 directed towards the interior of the reinforcing element.

In order to achieve suitable rigidity of the reinforcing element, the cavities 5a of the first laminar element are housed in at least some of the hollows left by the cavities 5b of the second laminar element.

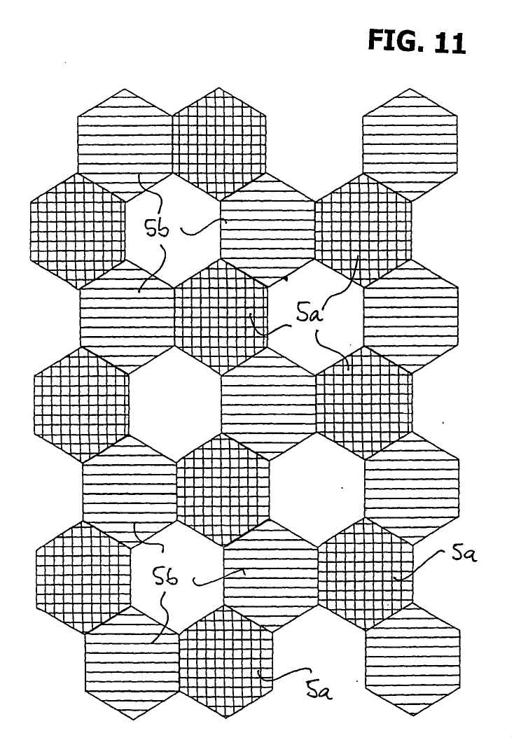

FIG. 11 shows schematically an arrangement which has been found to be particularly advantageous. According to this arrangement, the cavities 5a, 5b of both laminar elements are arranged in quincunx manner, the cavities being of hexagonal shape, so that when said laminar elements are attached to each other each hollow left by said cavities is surrounded by three cavities 5a of the first laminar element and by three cavities 5b of the second laminar element.

If so wished, the reinforcing element described can also include two sheets, of corrugated board for example, on its upper and lower parts.

It must be understood that the laminar element of this invention is not restricted to the uses described herein, since it can also be used as an alveolar tray, for example.

FIGS. 12 to 18 show other embodiments of utilisation of the laminar element of this invention.

In this case, the laminar element 1 has a sinusoidal profile and is formed from at least two layers 2, 3 of sinusoidal profile after they have been stamped attached together.

As can be seen from FIGS. 13 to 15, the layers 2, 3 which form the laminar element 1 of sinusoidal profile include a number of cuts 18a, 18b interrupted by points of material to prevent the separation of a layer before it is stamped and glued to the rest.

Each layer 2, 3 includes a plurality of cuts 18a, 18b, with the cuts 18a of one layer 2 displaced in relation to the cuts 18b of the adjacent layer 3 or layers. Said cuts 18a, 18b run the length of the undulations 21 of said layer 2, 3.

It is evident that there could be any number of layers, although for reasons of clarity only two layers are shown in FIG. 13.

If so wished, the laminar element 1 of this invention can be used as conventional corrugated board, as shown in FIG. 12, but with the advantage that much higher strength is achieved with the same quantity of material.

In this Figure, three laminar elements 1 have been attached one on top of the other, adding, if so wished, an upper sheet 19 and a lower sheet 20.

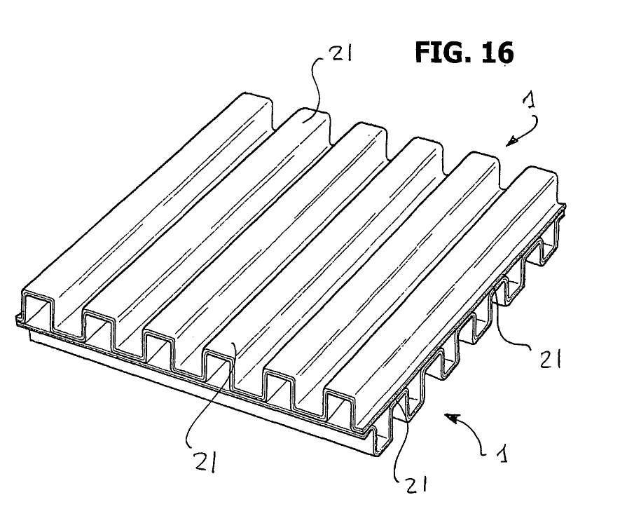

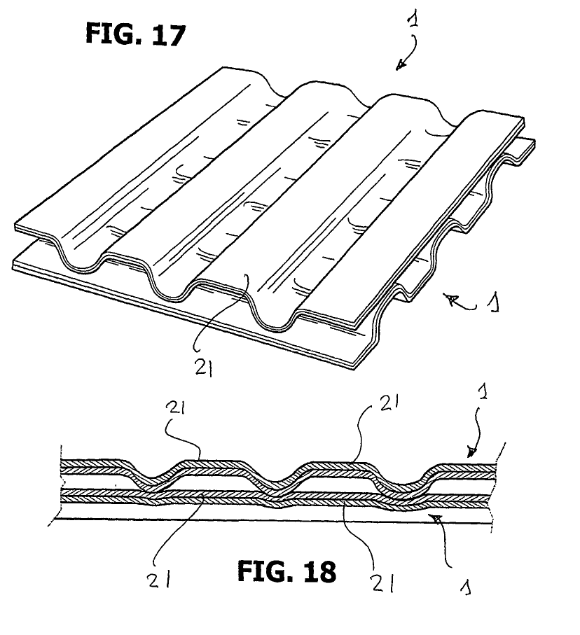

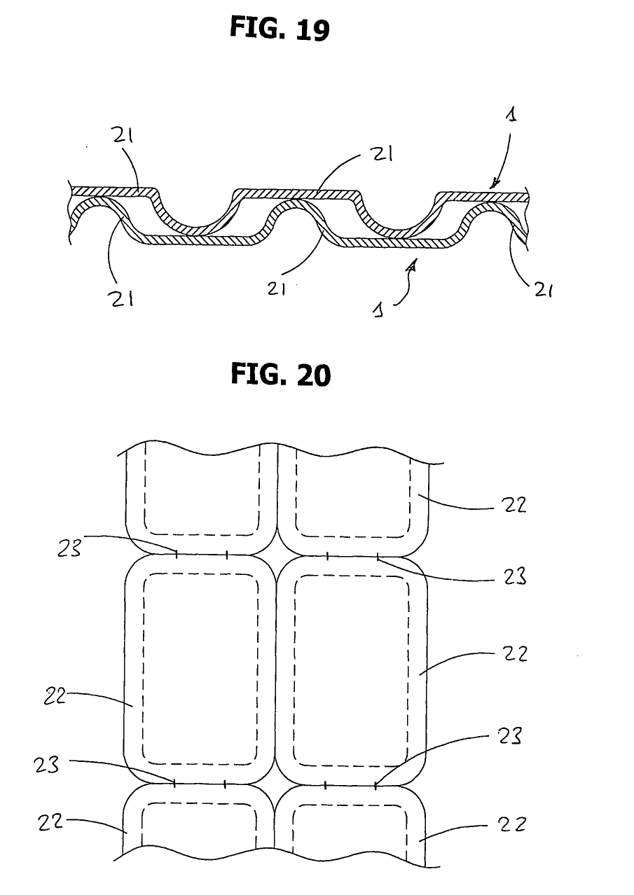

FIGS. 16 and 17 show two further utilisations of the laminar element of this invention as a reinforcing element.

This reinforcing element is formed by at least two laminar elements 1 of sinusoidal profile attached to each other, in such a way that the undulations 21 of one of the laminar elements are substantially perpendicular to the undulations 21 of the adjacent element or elements 1.

In the case of FIG. 17, the undulations of one of the laminar elements 1 are partially incrusted in the undulations 21 of the adjacent laminar element or elements 1, as can seen in greater detail in FIG. 18.

In FIG. 20 are shown a plurality of trays 22 that can be made with a variant embodiment of the machine shown in FIG. 3. Before entering in the stamping station 13, all these trays 22 are joined to each other by joining points 23. When the stamping is performed, said trays 22 are separated to each other, leaving the stamping station separated trays.

So, it is evident that it is not necessary the cutting station 18 for the fabrication of these trays 22.

Despite the fact that reference has been made to one specific embodiment of the invention, it will be clear to a person skilled in the art that the laminar element, the machine and the method described allow of numerous variations and modifications, and that all the details mentioned may be replaced by others that are technically equivalent, without departing from the scope of protection defined by the attached claims.

1. Method for fabricating a laminar element (1) which includes the stages of:
gluing of a plurality of layers of sheet material (2, 3, 4)); and
stamping of all the layers (2, 3, 4) together;
characterised in that:
the sticking together of the previously glued zones is carried out at the same time as the stamping of all the layers (2, 3, 4).

2. Method as claimed in claim 1, characterised in that the gluing and stamping of the layers (2, 3, 4) is carried out in a continuous and synchronised manner.

3. Method as claimed in claim 1, characterised in that it includes a pre-die-cutting stage of said plurality of layers of sheet material (2, 3, 4), with a number of cuts being made in said layers.

4. Method as claimed in claim 3, characterised in that the pre-die-cutting of said plurality of layers of sheet material (2, 3, 4) is also carried out continuously and synchronised with the other stages.

5. Method as claimed in claim 3, characterised in that in the pre-die-cutting stage a number of fold-lines are also made on said layers (2, 3, 4).

6. Method as claimed in claim 1, characterised in that it also includes a final stage of cutting of all the layers (2, 3, 4) together.

7. Method as claimed in claim 1, characterised in that it includes a stage of drawing of all the layers (2, 3, 4) together.

8. Method as claimed in claim 7, characterised in that said drawing stage is carried out before the gluing, and in that the layers (2, 3, 4) are separated in order to glue them.

9. Machine for fabricating a laminar element (1) made up of a plurality of layers of sheet material, which includes:
a plurality of gluing stations (12) for the layers of sheet material (2, 3, 4); and
a stamping station (13), in which all the layers (2, 3, 4) together are stamped;
characterised in that:
said stamping station (13) includes a pair of pressing elements, which stamp and glue together said previously glued layers.

10. Machine as claimed in claim 9, characterised in that said gluing stations (12) are adhesive-spraying stations.

11. Machine as claimed in claim 9, characterised in that it also includes a plurality of pre-die-cutting stations (11), on which a number of cuts and/or fold-lines are made on the layers of sheet material (2, 3, 4).

12. Machine as claimed in claim 11, characterised in that said pre-die-cutting stations (11) include a pair of rollers which are synchronised with each other.

13. Machine as claimed in claim 9, characterised in that it also includes a cutting station (17) situated downstream of the stamping station (13).

14. Machine as claimed in claim 9, characterised in that said pressing elements are rollers provided with at least one projecting part and one complementary inlet.

15. Machine as claimed in claim 9, characterised in that said pressing elements are cogged belts.

16. Machine as claimed in claim 9, characterised in that one of said pressing elements is of a deformable material with the pressure.

17. Machine as claimed in claim 16, characterised in that said deformable material with the pressure is foam.

18. Machine as claimed in claim 9, characterised in that it also includes a station (14) for drawing of all the layers of sheet materials (2, 3, 4) together.

19. Machine as claimed in claim 18, characterised in that the drawing station (14) is situated upstream of the gluing stations (12), and in that said gluing stations (12) include a separating station (15) associated with hem, which permits separation of the layers (2, 3, 4) from each other for gluing them.

20. Laminar element (1), which is formed from a plurality of layers of sheet material (2, 3, 4) and includes at least one cavity (5), each cavity (5) being formed from a number of cuts and folds formed in several layers making up the laminar element (1), defining a number of flaps (6), characterised in that said flaps (6) form a cavity (5) of polygonal profile.

21. Laminar element as claimed in claim 20, characterised in that the flaps (6) of one of the layers are displaced with respect to the flaps (6) of the adjacent layer or layers.

22. Laminar element as claimed in claim 21, characterised in that the flaps (6) of two adjacent layers are glued to each other in the zones of mutual contact.

23. Laminar element as claimed in claim 20, characterised in that said cavity (5) presents a hexagonal profile.

24. Laminar element as claimed in claim 20, characterised in that said cavity (5) presents a quadrangular profile.

25. Laminar element as claimed in claim 23, characterised in that the flaps (6) which define a cavity (5) of hexagonal profile are three in number, with each of said flaps being triangular (6a) and each flap (6a) including four fold lines which define a rectangular central zone (7), a triangular upper zone (8) and two side zones which are also triangular (9).

26. Laminar element as claimed in claim 20, characterised in that each cavity (5) includes at least one cap (10) of laminar material which covers the hollow left by the cuts in the cavity.

27. Laminar element as claimed in claim 26, characterised in that the profile of said cap or caps (10) coincides substantially with the profile of the cavity.

28. Laminar element as claimed in claim 26, characterised in that said cap (10) is situated interposed between two of the layers which make up the laminar element (1).

29. Laminar element as claimed in any of claims 20 to 28, characterised in that said laminar materials are cardboard and/or paper.

30. Reinforcing element, which is formed from a pair of laminar elements (1) provided with a plurality of cavities (5) as claimed in claim 18, characterised in that said laminar elements (1) are attached to each other in such a way that the projecting part of the cavities (5) is directed towards the interior of the reinforcing element.

31. Reinforcing element as claimed in claim 30, characterised in that the cavities (5) of both laminar elements (1) are arranged in quincunx manner, so that the cavities (5a) of the first laminar element (1) fit into at least some of the hollows left by the cavities (5b) of the second laminar element (1).

32. Reinforcing element as claimed in claim 30, characterised in that the cavities (5) of both laminar elements (1) can have a hexagonal profile, with the cavities (5) of both laminar elements (1) being arranged in such a way that a hollow left by said cavities is surrounded by three cavities (5a) of the first laminar element (1) and by three cavities (5b) of the second laminar element (1).

33. Packaging element, formed from a single laminar element (1) as claimed in claim 20, characterised in that it includes at least one cavity (5) and a cap (10) interposed between two layers of sheet material (2, 4), covering the hollow left by the flaps (6) in the cavity or cavities (5).

34. Packaging element as claimed in claim 33, characterised in that it includes a layer of sheet material by way of cover.

35. Protecting element, formed from a single laminar element (1) as claimed in claim 18, which includes a plurality of cavities (5), characterised in that it includes a plurality of fold-lines (16) between said cavities (5).

36. Laminar element of sinusoidal profile, characterised in that it includes at least two layers of sheet material (2, 3) of sinusoidal profile attached to each other.

37. Laminar element as claimed in claim 36, characterised in that each layer (2, 3) includes a plurality of cuts (18a, 18b), the cuts (18a) of one layer being displaced in relation to the cuts (18b) of the adjacent layer or layers (3).

38. Laminar element as claimed in claim 37, characterised in that said cuts (18a, 18b) run the length of the undulations (21) of said layer (2, 3).

39. Reinforcing element formed by at least two laminar elements (1) of sinusoidal profile as claimed in claim 34 attached to each other, characterised in that the undulations (21) of one of the laminar elements (1) are substantially perpendicular to the undulations (21) of the adjacent laminar element or elements (1).

40. Reinforcing element as claimed in claim 39, characterised in that the undulations (21) of one of the laminar elements (1) are partially incrusted in the undulations (21) of the adjacent laminar element or elements (1).

41. Reinforcing element formed by at least two laminar elements (1), of sinusoidal profile as claimed in claim 34 attached to each other, characterised in that the undulations (21) of one of the laminar elements (1) are substantially parallel to the undulations (21) of the adjacent laminar element or elements (1).
